(19) United States
(12) Patent Application Publication
(10) Pub. No.: US 2012/0236147 A1
(43) Pub. Date: Sep. 20, 2012

(54) SYSTEMS AND METHODS OF CENTRAL STATION VIDEO ALARM VERIFICATION USING AN ON SITE USER VIDEO SYSTEM

(75) Inventors: Kenneth L. Addy, Massapequa, NY (US); David S. Zakrewski, Babylon, NY (US)

(73) Assignee: Honeywell International Inc., Morristown, NJ (US)

(21) Appl. No.: 13/416,575

(22) Filed: Mar. 9, 2012

Related U.S. Application Data
(60) Provisional application No. 61/452,714, filed on Mar. 15, 2011.

(51) Int. Cl. H04N 7/18

(52) U.S. Cl. 348/143; 348/E07.085

(57) ABSTRACT

Systems and methods that balance the need for privacy by a primary user with the need for remote access by a secondary user to an on-site video surveillance system are provided. Methods include defining at least one predetermined condition, determining when the at least one predetermined condition is met, providing a primary user with remote access to an on-site video surveillance system in a region regardless of when the at least one predetermined condition is met, and providing a secondary user with remote access to the on-site video surveillance system in the region only when the at least one predetermined condition is met.

### CROSS-REFERENCE TO RELATED APPLICATIONS

This application claims priority to and the benefit of the filing date of U.S. Provisional Patent Application No. 61/452,714 filed Mar. 15, 2011 and titled “Systems and Methods of Central Station Video Alarm Verification Using an On Site User Video System”. U.S. Provisional Patent Application No. 61/452,714 is hereby incorporated by reference.

### FIELD

The present invention relates generally to alarm systems and video surveillance. More particularly, the present invention relates to systems and methods of a central station remotely verifying a video alarm using an on-site video surveillance system.

### BACKGROUND

There is currently a trend for home owners or other building managers to install video cameras or other video surveillance systems within their homes or buildings in order look into or otherwise observe the building while they are away. For example, a home owner may want to remotely observe his home to check on the status of children, elderly relatives, pets, or others who are in the home.

Many home owners prefer that a system for remote video surveillance be private. Therefore, access to these systems is typically via a private website or personal digital assistant (PDA) with security provisions.

For example, remote access to cameras in a home or other building can be via a website over a WAN, LAN, or PDA. The privacy of the website can be preserved by requiring a viewing operator to log in to the in-home system with a password. In known systems, access to the website and the remote video does not depend on the condition of the website. Therefore, a remote user may log in regardless of the time of day and regardless of alarm or emergency events that may or may not be occurring.

However, verification of alarm events by a central station is increasingly important. For example, it is often more cost effective and convenient to verify alarm events before police or other emergency personnel are dispatched to a remote site. Traditional in-home video surveillance systems that use security provisions often prevent remote verification by a central station, but if access is granted to the central station, then the privacy of the home owner is compromised.

There is thus a continuing, ongoing need for systems and methods that balance the need for privacy by a home owner with the need for remote access by a central station to an in-home video surveillance system.

### BRIEF DESCRIPTION OF THE DRAWINGS

FIG. 1 is flow diagram of a method in accordance with disclosed embodiments; and

FIG. 2 is a block diagram of a system for carrying out the method of FIG. 1 and others disclosed herein.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include systems and methods that balance the need for privacy by a home owner or building operator with the need for remote access by a central station to an in-home or on-site video surveillance system. For example, systems and methods disclosed herein can provide primary and secondary users with different capabilities for remote access to an on-site video surveillance system. The primary user can be a home owner of the home or operator of the building in which the on-site video surveillance system is installed, and the secondary user can be an operator at a remote central station that is in communication with the on-site video surveillance system.

The primary user can have remote access to the on-site video surveillance system at all times. However, the secondary user can have remote access to the on-site video surveillance system only under predetermined conditions. For example, the predetermined conditions can include an alarm event or any other identified event, for example, a predetermined time of the day or night. In some embodiments, the primary user can identify the predetermined conditions, events, or actions that allow remote access by the secondary user. Accordingly, the primary user can control remote access to the on-site video surveillance system.

When the predetermined condition includes the occurrence of an alarm event, the secondary user can remotely access the on-site video surveillance system to verify the alarm. Thus, the primary user can maintain the benefit of a private or semi-private on-site video surveillance system, but allow additional, controlled access during a predetermined condition.

In some embodiments, no additional infrastructure is needed. That is, a central station can obtain remote access to an existing on-site video surveillance system using previously established infrastructure. For example, a known on-site video surveillance system can be modified and enabled for dual use as a video alarm verification system and for granting access to a central station operator under predetermined conditions.

The primary user can define and identify the predetermined conditions locally and/or remotely. For example, the primary user can provide input to a central panel local to the on-site video surveillance system.

In some embodiments, remote access to the on-site video surveillance system can be facilitated by a security-enabled website. For example, the website can be password protected. In these embodiments, the primary user can access the website to define and identify the predetermined conditions. For example, the website can display a menu or other input mechanisms for the primary user to select when defining and identifying the predetermined conditions.

An on-site video surveillance system can include a plurality of video surveillance cameras or other data collection devices, a central panel, and one or more recording devices, for example, a digital video recorder (DVR). The surveillance cameras can capture images of the monitored region on video data streams and can send the video data streams to the recording device for preservation. Accordingly, remote access to the on-site video surveillance system can include remote access to the live video data streams of one or more surveillance cameras in the on-site surveillance system and/or remote access to recorded video data streams in the recording device. Remote access can also include access to the central panel of the on-site system. In some embodiments, the predetermined conditions can determine which devices the secondary user can remotely access and when the secondary user can remotely access those devices.

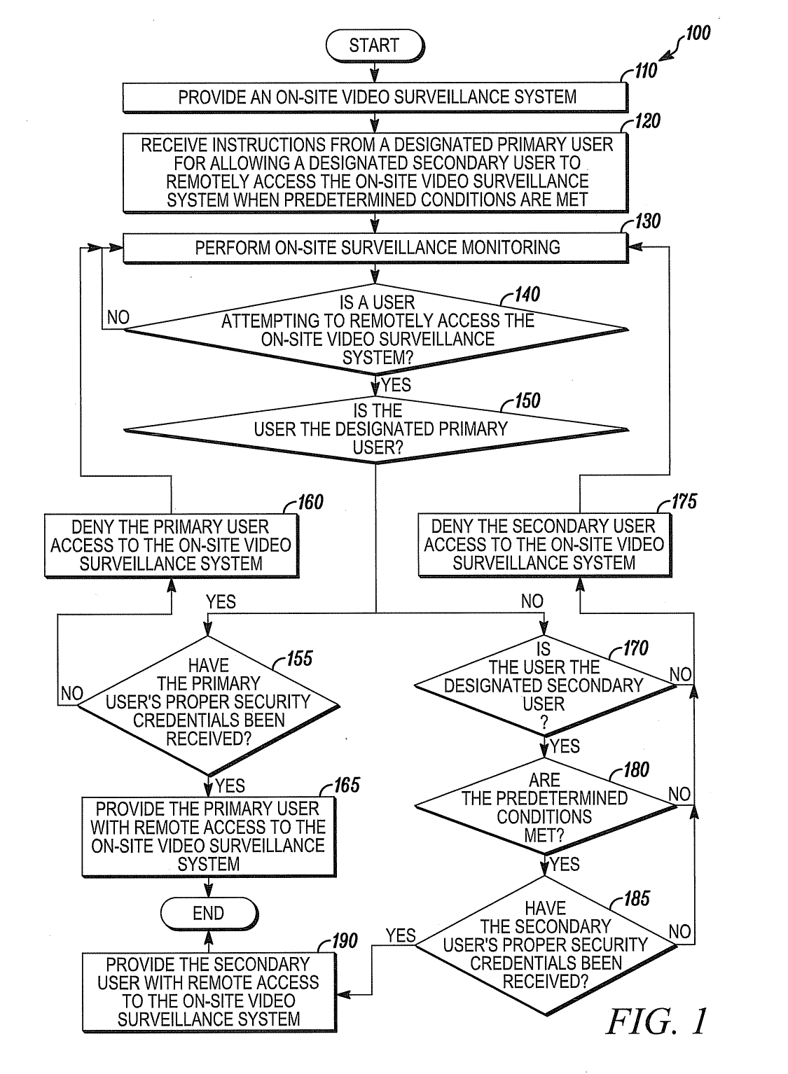

FIG. 1 is flow diagram of a method 100 in accordance with disclosed embodiments. As seen in FIG. 1, the method 100 can include providing an on-site video surveillance system as in 110. Then, the method 100 can receive instructions from a designated primary user for allowing a designated secondary user to remotely access the on-site video surveillance system when predetermined conditions are met as in 120. For example, the primary user can provide instructions defining the predetermined conditions. After this set up process is complete, the method 100 can perform in-home surveillance monitoring as in 130.

While the method 100 is performing on-site video surveillance monitoring as in 130, the method 100 can determine if a user is attempting to remotely access the on-site video surveillance system as in 140. If not, then the method 100 can continue performing on-site video surveillance monitoring as in 130.

However, if the method 100 determines that a user is attempting to remotely access the on-site video surveillance system as in 140, then the method 100 can determine if the user is the designated primary user as in 150.

If the method 100 determines that the user is the designated primary user as in 150, then the method 100 can determine if the primary user's proper security credentials have been received as in 155. For example, the method 100 can determine if the designated primary user has entered the correct password into a website that facilitates remote access to the on-site video surveillance system. If not, then the method 100 can deny the primary user remote access to the on-site video surveillance system as in 160 and continue performing in-home surveillance monitoring as in 130.

However, if the method 100 determines that the primary user's proper security credentials have been received as in 155, then the method 100 can provide the primary user with remote access to the on-site video surveillance system as in 165.

If the method 100 determines that the user attempting to remotely access the on-site video surveillance system is not the designated primary user as in 150, the method 100 can determine if the user is the designated secondary user as in 170. If not, then the method 100 can deny remote access to the on-site video surveillance system as in 175 and continue performing on-site video surveillance monitoring as in 130.

However, if the method 100 determines that the user attempting to remotely access the on-site video surveillance system is the designated secondary user as in 170, then the method 100 can determine if the predetermined conditions are met as in 180. That is, the method 100 can determine if the conditions identified by the primary user as in 120 for allowing the secondary user remote access are occurring. If not, then the method 100 can deny the secondary user remote access to the on-site video surveillance system as in 175 and continue performing on-site video surveillance monitoring as in 130.

If the method 100 determines that the predetermined conditions are met as in 180, then the method 100 can determine if the secondary user's proper security credentials have been received as in 185. For example, the method 100 can determine if the designated secondary user has entered the correct password into a website that facilitates remote access to the on-site video surveillance system. If not, then the method 100 can deny the secondary user remote access to the on-site surveillance system as in 175 and continue performing on-site video surveillance monitoring as in 130.

However, if the method 100 determines that the secondary user's proper security credentials have been received as in 185, then the method 100 can provide the secondary user with remote access to the on-site surveillance system as in 190.

In some embodiments, the method 100 can omit determining if a user attempting to remotely access the on-site video surveillance system is a designated secondary user as in 170. Instead, while the method 100 is performing on-site video surveillance monitoring as in 130, the method can determine when the predetermined conditions identified as in 120 are met as in 180. When the predetermined conditions are met as in 180, the method 100 can provide the secondary user remote access to the in-home surveillance system as in 190. That is, the method 100 need not wait for the secondary user to solicit remote access before allowing remote access when the predetermined conditions are met. Indeed, the method 100 can provide the secondary user with unsolicited remote access.

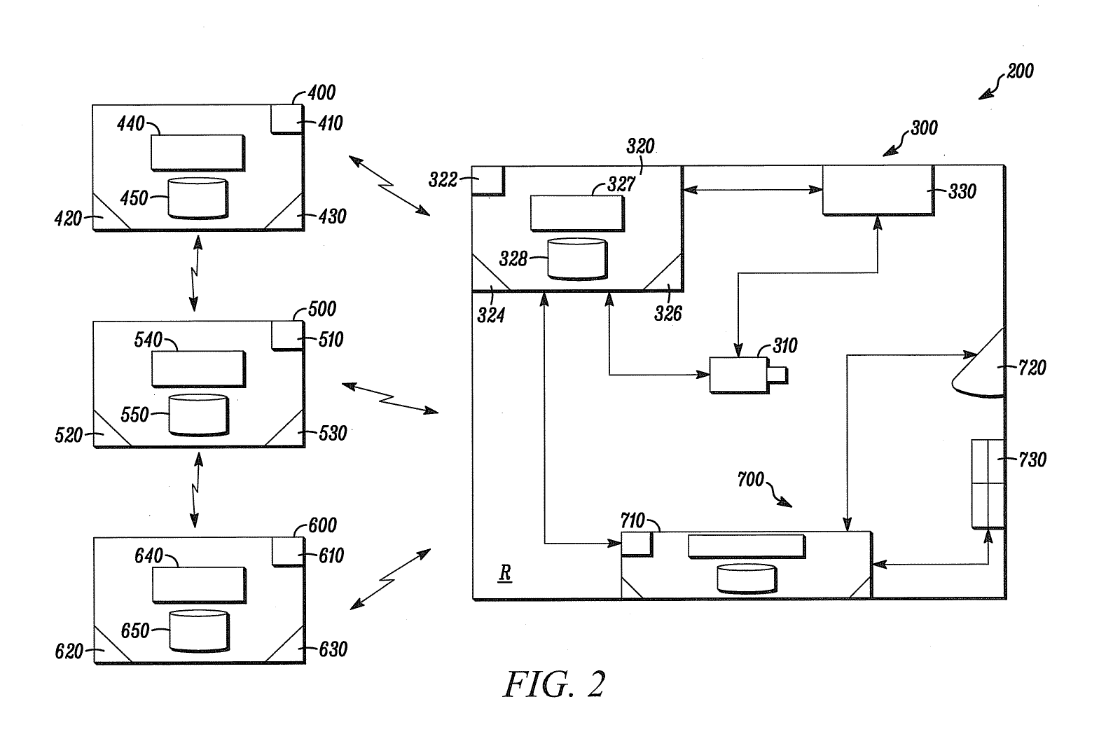

FIG. 2 is a block diagram of a system 200 for carrying out the method of FIG. 1 and others disclosed herein. As seen in FIG. 2, the system 200 can include an on-site video surveillance system 300, a central station 400, a web server 500, and a primary user device 600. The on-site video surveillance system can monitor a region R. For example, the region R could include a home, a room, or any other building in which the system 300 is installed.

The on-site video surveillance system 300 can include a plurality of cameras 310 or other video capture devices, a central panel 320, and a recording device 330, for example, a digital video recorder (DVR). The plurality of cameras 310, the central panel 320 and the recording device 330 can be in wired or wireless communication with each other.

The plurality of cameras 310 can be placed throughout the region R so that the cameras 310 monitor all areas of interest in the region R. Video data streams from each of the plurality of cameras 310 can be sent to one or both of the central panel 320 and the recording device 330. When the recording device 330 receives video data streams from a camera 310, the recording device 330 can store the video data streams.

The central panel 320 can include one or more transceivers 322, one or more programmable processors 324, and executable control software 326 as would be understood by those of ordinary skill in the art. In some embodiments, the central station 320 can also include a user interface device 327 and/or a memory device 328, for example, a database or server.

The executable control software 326 can implement the method shown and described in FIG. 1 as well as others described herein. Further, the executable control software 326 can be stored on a transitory or non-transitory local computer readable medium, including, but not limited to, local computer memory, RAM, optical storage media, magnetic storage media, flash memory, etc.

The transceiver 322 can include any type of transceiver as would be known by one of ordinary skill in the art that can facilitate communication with the plurality of cameras 310 and the recording device 330, as well as with the central station 400, the web server 500, and the primary user device 600.

The central station 400 can be the secondary user and/or facilitate remote access to the on-site video surveillance system 300 by a secondary user, for example, an operator at the central station 400. The central station 400 can be remotely located from the region R and can include one or more transceivers 410, one or more programmable processors 420, executable control software 430 as would be understood by those of ordinary skill in the art, a user interface device 440, and a memory device 450, for example, a database or server. The executable control software 430 can be stored on a transitory or non-transitory local computer readable medium, including, but not limited to, local computer memory, RAM, optical storage media, magnetic storage media, flash memory, etc.

The web server 500 can facilitate remote access to the on-site video surveillance system 200 by the central station 400 and/or by the primary user device 600. For example, the web server 500 can support a website with security provisions that provides and/or facilitates access to the system 300. The web server 500 can be remotely located from the region R and can include one or more transceivers 510, one or more programmable processors 520, executable control software 530 as would be understood by those of ordinary skill in the art, a user interface device 540, and a memory device 550, for example, a database or server. The executable control software 550 can be stored on a transitory or non-transitory local computer readable medium, including, but not limited to, local computer memory, RAM, optical storage media, magnetic storage media, flash memory, etc.

Finally, the primary user device 600 can include a smart phone, a PDA, or the like that a primary user can operate to remotely access the on-site video surveillance system 300 either directly or via the web server 500. The primary user device 600 can be mobile and, at times, be remotely located from the region R. The device 600 can include one or more transceivers 610, one or more programmable processors 620, executable control software 630 as would be understood by those of ordinary skill in the art, a user interface device 640, and a memory device 650, for example, a database or server. The executable control software 650 can be stored on a transitory or non-transitory local computer readable medium, including, but not limited to, local computer memory, RAM, optical storage media, magnetic storage media, flash memory, etc.

The on-site video surveillance system 300, the central station 400, the web server 500, and the primary user device 600 can be in bi-directional communication with one other via the respective transceivers 322, 410, 510, 610. In some embodiments, the central station 400 and the primary user device 600 can communicate with the on-site video surveillance system 300 directly, and in some embodiments, the central station 400 and the primary user device 600 can communicate with the on-site video surveillance system 300 via the web server 500.

In some embodiments, the on-site video surveillance system 300 can also be in wired or wireless communication with an alarm/security system 700 monitoring the region R. Additionally or alternatively, the on-site video surveillance system 300 can be tied to the alarm/security system 700 in a cloud system.

The alarm/security system 700 can include an alarm system central panel 710 that can be armed or disarmed and that can monitor, for example, doors 720 and windows 730 in the region R. The alarm system central panel 710 can include one or more transceivers 710, one or more programmable processors 720, executable control software 730 as would be understood by those of ordinary skill in the art, a user interface device 740, for example, a keypad, and a memory device 750, for example, a database or server. The executable control software 750 can be stored on a transitory or non-transitory local computer readable medium, including, but not limited to, local computer memory, RAM, optical storage media, magnetic storage media, flash memory, etc.

The on-site video surveillance system 300, for example, the central panel 300, can communicate with the alarm system 700, for example, the alarm system central panel 710 so that the on-site video surveillance system 300 and elements thereof are aware of the current state of the alarm system 700. In some embodiments, the on-site video surveillance system 300 can use the current state of the alarm system 700 to further determine when and if to provide a secondary user, for example, the central panel 400, with remote access to the system 300.

For example, if a door 720 in the region R is left open, but the alarm system 700 is disarmed, the on-site video surveillance system 300 can determine that remote access by a secondary user 400 should be prevented. However, if the door 720 is left open and the alarm system 700 is armed, then the on-site video surveillance system 300 can determine that remote access by a secondary user 400 should be permitted.

In some embodiments, when the alarm system 700 is armed away (i.e. the primary user is not in the region R), remote access to the on-site video surveillance system 300 can proceed as described above. However, when the alarm system 700 is alarmed stay (i.e. the primary user is in the region R), some or all remote access to the on-site video surveillance system 300 can be restricted and/or prevented.

In other embodiments, a time schedule can be defined for when remote access to the on-site video surveillance system 300 proceeds as described above and for when some or all remote access to the system 300 is restricted and/or prevented. For example, remote access to the system can be restricted during nighttime hours, when a primary user residing in the region R may want additional privacy. Additionally or alternatively, some or all remote access to the system 300 can be restricted and/or prevented when a predetermined code is entered into a keypad 740 associated with the alarm system 700.

It is to be understood that even when remote access to the on-site video surveillance system 300 is restricted and/or prevented, the system 300 still monitors the region R and cameras 310 in the region R still capture images of the region R on video data streams that can be recorded in the recording device 330.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the sprit and scope of the invention.

What is claimed is:

1. A method comprising:
defining at least one predetermined condition;
determining when the at least one predetermined condition is met;
providing a primary user with remote access to an on-site video surveillance system in a region regardless of when the at least one predetermined condition is met; and
providing a secondary user with remote access to the on-site video surveillance system in the region only when the at least one predetermined condition is met.

2. The method of claim 1 wherein defining the at least one predetermined condition includes receiving user input from the primary user identifying the at least one predetermined condition.

3. The method of claim 1 wherein the at least one predetermined condition includes at least one of an occurrence of an associated alarm or a predetermined time period.

4. The method of claim 1 further comprising receiving security credentials for the primary user before providing the primary user with remote access to the on-site video surveillance system in the region.

5. The method of claim 1 further comprising receiving security credentials for the secondary user before providing the secondary user with remote access to the on-site video surveillance system in the region.

6. The method of claim 1 further comprising denying the secondary user with remote access to the on-site video surveillance system in the region the in absence of the at least one predetermined condition being met.

7. The method of claim 1 wherein providing remote access to the on-site video surveillance system in the region includes at least one of providing remote access to at least one live video data stream associated with at least one surveillance camera in the region, providing remote access to at least one video data stream saved in a recording device, or providing remote access to a control panel associated with the on-site video surveillance system.

8. The method of claim 1 further comprising receiving a request for remote access from the secondary user before providing the secondary user with remote access to the on-site video surveillance system in the region.

9. A system comprising:
a transceiver;
a programmable processor; and
executable software stored on a non-transitory computer readable medium for:
defining at least one predetermined condition;
determining when the at least one predetermined condition is met;
providing a primary user with remote access to an on-site video surveillance system in a region regardless of when the at least one predetermined condition is met; and
providing a secondary user with remote access to the on-site video surveillance system in the region only when the at least one predetermined condition is met.

10. The system of claim 9 further comprising a user input mechanism for receiving user input from the primary user, the user input defining the at least one predetermined condition.

11. The system of claim 9 wherein the at least one predetermined condition includes at least one of an occurrence of an associated alarm or a predetermined time period.

12. The system of claim 9 wherein the transceiver receives security credentials for the primary user before the executable software provides the primary user with remote access to the on-site video surveillance system in the region.

13. The system of claim 9 wherein the transceiver receives security credentials for the secondary user before the executable software provides the secondary user with remote access to the on-site video surveillance system in the region.

14. The system of claim 9 further comprising the executable control software denying the secondary user with remote access to the on-site video surveillance system in the region in the absence of the at least one predetermined condition being met.

15. The system of claim 9 wherein providing remote access to the on-site video surveillance system in the region includes at least one of providing remote access to at least one live video data stream associated with at least one surveillance camera in the region, providing remote access to at least one video data stream saved in a recording device, or providing remote access to a control panel associated with the on-site video surveillance system.

16. The system of claim 9 further comprising the transceiver receiving a request for remote access from the secondary user before providing the secondary user with remote access to the on-site video surveillance system in the region.

17. The system of claim 9 wherein the transceiver is in communication with at least one of a surveillance camera in the region, a recording device in the region, or an alarm system in the region.

18. The system of claim 9 wherein the transceiver is in communication with at least one of a remote central station, a remote web server, or primary user device.

19. A method comprising:
performing on-site video surveillance monitoring of a region;
determining when a predetermined condition is met; and
providing a primary user with remote access to an on-site video surveillance system in the region regardless of when the at least one predetermined condition is met; and
providing a secondary user with remote access to the on-site video surveillance system in the region only when the at least one predetermined condition is met.

20. The method of claim 19 further comprising providing the secondary user with unsolicited remote access to the on-site video surveillance system in the region when the at least one predetermined condition is met.
